(19) United States
(12) Patent Application Publication
(10) Pub. No.: US 2014/0030017 A1
(43) Pub. Date: Jan. 30, 2014

(54) ASSEMBLED FURNITURE

(71) Applicant: Shen Luo, Guangzhou (CN)

(72) Inventor: Shen Luo, Guangzhou (CN)

(21) Appl. No.: 13/558,562

(22) Filed: Jul. 26, 2012

(51) Int. Cl. F16B 3/00

(52) U.S. Cl. 403/375

(57) ABSTRACT

An assembled furniture comprising a plurality of plates, wherein two adjacent plates are provided respectively with a through hole and a bump that are mutually matched, a second through hole is arranged on the bump, the bump is penetrated into the through hole, and a locking block is plugged in the second through hole of the bump. The bump of a plate is penetrated into the through hole of an adjacent plate, and then the locking block is plugged into the second through hole of the bump, to form various furniture. During disassembly, the locking block is pulled out from the second through hole of the bump first, and then the bump is pulled out from the through hole, to disassemble the furniture. The assembly and disassembly are convenient and quick.

### BACKGROUND OF THE INVENTION

1. Field of the Invention

This application relates to furniture, in particular to, assembled furniture that is easy in assembly and disassembly.

2. Description of the Related Art

In existing furniture, some are formed by connecting plates by screws or rivets, and some are formed by welding two adjacent plates. However, the shape of the furniture has been fundamentally fixed; assembly and disassembly are troublesome, therefore wasting time and energy. It is virtually impossible to assemble furniture as one wish.

### SUMMARY OF THE INVENTION

In order to overcome the shortcomings of the prior art, the purpose of the present application is to provide an assembled furniture that is easy in assembly and disassembly.

In accordance with an aspect of the present invention, an assembled furniture comprises plates forming each face, wherein two adjacent plates are provided respectively with a through hole and a bump that are mutually matched, a second through hole is arranged on the bump, the bump is penetrated into the through hole, and a locking block is plugged in the second through hole of the bump.

Preferably, the transverse distance of the tail part of the locking block is larger than that of the head part, and the head part is penetrated into the second through hole of the bump.

Preferably, the head part of the locking block is provided with a notch, the transverse distance of the head part is slightly larger than the vertical distance of the inner wall of the second through hole, and the head part is provided with a chamfer.

The present invention has the following beneficial effects: the bump of a plate is penetrated into the through hole of an adjacent plate, and then the locking block is plugged into the second through hole of the bump, to form various furniture; during the disassembly, the locking block is pulled out from the second through hole of the bump first, and then the bump is pulled out from the through hole, to disassemble the furniture. The assembly and disassembly are convenient and quick.

The various features of novelty which characterize the invention are pointed out with particularity in the claims annexed to and forming a part of the disclosure. For a better understanding of the invention, its operating advantages, and specific objects attained by its use, reference should be had to the drawing and descriptive matter in which there are illustrated and described preferred embodiments of the invention.

### BRIEF DESCRIPTION OF THE DRAWINGS

In the drawings:

FIG. 1 is a structure diagram of one embodiment of the present invention;

FIG. 2 is a structure diagram of a locking block in accordance with one embodiment of the present invention;

FIG. 3 is another structure diagram of a locking block in accordance with an embodiment of the present invention.

FIG. 4 is a partial decomposition diagram of FIG. 1.

### DETAILED DESCRIPTION OF THE PRESENTLY PREFERRED EMBODIMENTS

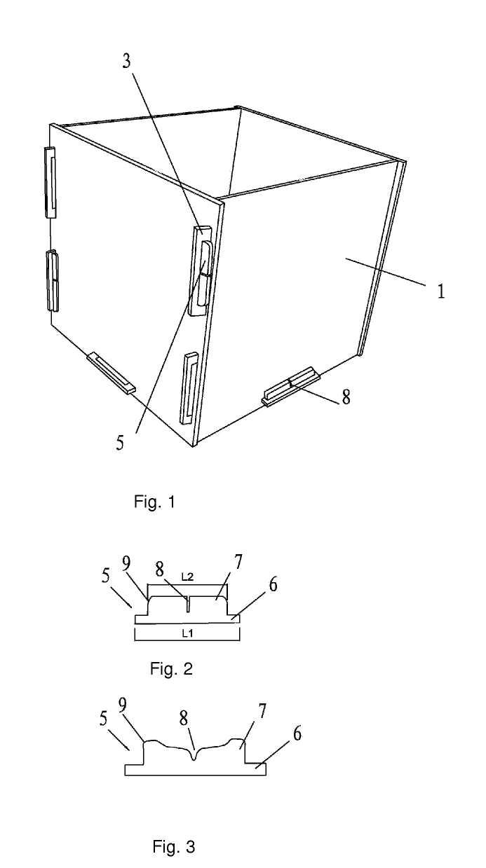

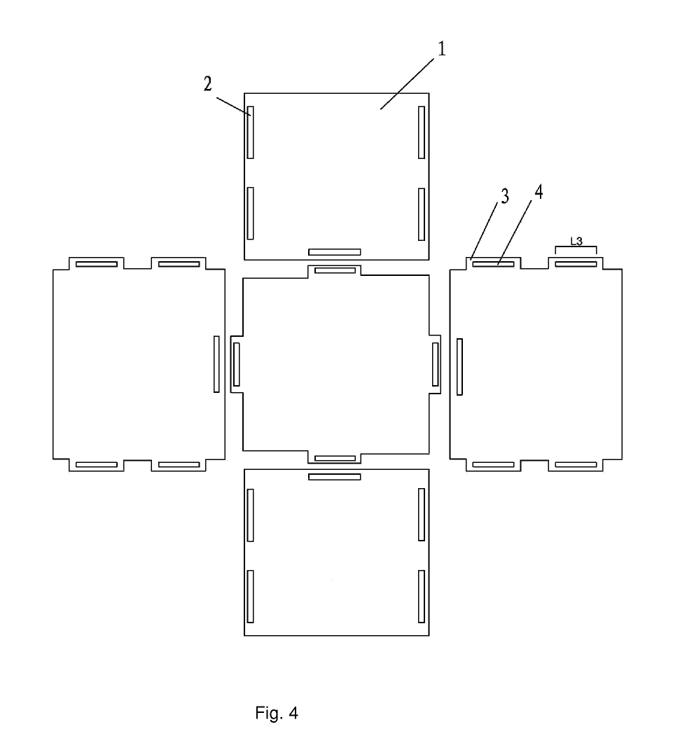

With reference to FIG. 1 to FIG. 4, an assembled furniture in accordance with an embodiment of the present invention comprises plates 1 forming each face, wherein two adjacent plates 1 are provided with a through hole 2 and a bump 3 that are mutually matched, a second through hole 4 is arranged on the bump 3, the bump 3 is penetrated into the through hole 2, and a locking block 5 is plugged in the second through hole 4 of the bump 3. The bump 3 of a plate 1 is penetrated into the second through hole of an adjacent plate, and then the locking block 5 is plugged into the second through hole 4 of the bump 3, to form various furniture. During the disassembly, the locking block 5 is pulled out from the second through hole 4 of the bump 3 first, and then the bump 3 is pulled out from the through hole 2, to disassemble the furniture, the assembly and disassembly are convenient and quick.

In accordance with an embodiment of the present invention, the plates are modeled from various plastic plates or wood fiber boards or metal sheets by laser cutting or stamping or mold casting.

To prevent the locking block 5 from falling off the through hole 2 and to ensure that the locking block 5 effectively locks the two adjacent plates, the transverse distance L1 of the tail part 6 of the locking block 5 is larger than that of the head part 7, and the head part 7 is penetrated into the second through hole 4 of the bump 3.

Preferably, the head part 7 of the locking block 5 is provided with a notch 8, the transverse distance L2 of the head part 7 is slightly larger than the vertical distance L3 of the inner wall of the second through hole 4, and the head part 7 is provided with a chamfer 9. The arrangement of the chamfer is to penetrate the locking block 5 into the through hole 2 conveniently; after penetrated into the through hole 2, the locking block 5 can be arranged on the through hole 2 tightly, so as to further prevent the locking block 5 from falling off.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

I claim:

1. An assembled furniture comprising a plurality of plates, wherein two adjacent plates are provided with a through hole and a bump that are mutually matched, a second through hole is arranged on the bump, the bump is penetrated into the through hole, and a locking block is plugged in the second through hole of the bump.

2. The assembled furniture of claim 1 wherein the transverse distance of the tail part of the locking block (L1) is larger than that of the head part (L2), and the head part is penetrated into the second through hole of the bump.

3. The assembled furniture of claim 2 wherein the head part of the locking block is provided with a notch, the transverse distance of the head part (L2) is slightly larger than the vertical distance of the inner wall of the second through hole (L3), and the head part is provided with a chamfer.
